(19) United States
(12) Patent Application Publication
(10) Pub. No.: US 2015/0027644 A1
(43) Pub. Date: Jan. 29, 2015

(54) SUNSHADE ASSEMBLY

(71) Applicant: MACAUTO INDUSTRIAL CO., LTD., Tainan City (TW)

(72) Inventors: Paul Lin, Tainan City (TW); Hung-Ming YEN, Tainan City (TW)

(73) Assignee: MACAUTO INDUSTRIAL CO., LTD., Tainan City (TW)

(21) Appl. No.: 14/157,004

(22) Filed: Jan. 16, 2014

(30) Foreign Application Priority Data
Jul. 23, 2013 (TW) 102213849

(51) Int. Cl. E06B 9/42

(52) U.S. Cl. CPC E06B 9/42
USPC 160/323.1

(57) ABSTRACT

A sunshade assembly includes a winding tube, a screen, an adhesive unit and two clamp rings. The screen has a connection portion that is connected to the winding tube and that has two opposite end sections. The adhesive unit is disposed between the connection portion and the winding tube to adhere together the connection portion and the winding tube. The clamp rings respectively clamp the end sections against the winding tube.

### CROSS-REFERENCE TO RELATED APPLICATION

This application claims priority to Taiwanese Application No. 102213849, filed on Jul. 23, 2013.

### BACKGROUND OF THE INVENTION

1. Field of the Invention

The invention relates more particularly to a shading assembly adapted to be installed beneath a vehicle sunroof.

2. Description of the Related Art

FIGS. 1 and 2 illustrate a conventional sunshade assembly 1 that is adapted to be mounted beneath a vehicle sunroof (not shown). The conventional sunshade assembly 1 includes two parallel guide rails 11, two mounting seats 12 that are respectively disposed rearward of the guide rails 11, a winding shaft 13 that is disposed rotatably between the mounting seats 12, a screen 14 that is extendably wound around the winding shaft 13, and a pull rod 15 that is movable slidably between the guide rails 11 and that drives the screen 14 to be extended or retracted relative to the winding shaft 13.

The screen 14 has a connection portion 141 that is proximate to the winding shaft 13, an extendable portion 142 that is opposite to the connection portion 141 and that is connected to the pull rod 15, and two opposite lateral sides each of which interconnects the connection portion 141 and the extendable portion 142. In addition, the conventional sunshade assembly 1 generally includes a double-sided tape 16 that is disposed between and attached to the connection portion 141 and the winding shaft 13.

In use, when the screen 14 is retracted relative t the winding shaft 13, the screen 14 is wound around the winding shaft 13 such that the extendable portion 142 is proximate to the winding shaft 13. When the extendable portion 142 is driven to move away from the winding shaft 13, the screen 14 is extended along the guide rails 11 for covering the vehicle sunroof. In order to ensure the connection between the screen 14 and the winding shaft 13 when the conventional sunshade assembly 1 is in use, the conventional sunshade assembly 1 has to be subjected to a tension durability test before being dispatched from a factory. When conducting the tension durability test, an external force is applied to drive the screen 14 to move away from the winding shaft 13. However, since the double-sided tape 16 cannot provide a sufficient bonding strength between the connection portion 141 of the screen 14 and the winding shaft 13, the adhesion strength of the double-sided tape 16 is gradually weakened. The connection portion 141 may loosen from the winding shaft 13, which may result in uneven connection between the connection portion 141 and the winding shaft 13. At worst, the connection portion 141 may be disconnected from the winding shaft 13. Thus, the probability of the conventional sunshade assembly 1 passing the tension durability test is unsatisfactory, which results in poor production yield.

### SUMMARY OF THE INVENTION

Therefore an object of the present invention is to provide a sunshade assembly overcome the aforesaid drawbacks of the prior art.

According to the present invention, a sunshade assembly includes a winding tube, a screen, an adhesive unit and two clamp rings.

The screen is extendably wound around the winding tube. The screen has a connection portion that extends along a length of the winding tube and that is connected to the winding tube, an extendable portion that is opposite to the connection portion, and two opposite lateral sides each of which interconnects the connection portion and the extendable portion. The connection portion has two opposite end sections that are respectively connected to the lateral sides.

The adhesive unit is disposed between the connection portion and the winding tube to adhere together the connection portion and the winding tube.

The clamp rings respectively clamp the end sections against the winding tube.

### BRIEF DESCRIPTION OF THE DRAWINGS

Other features and advantages of the present invention will become apparent in the following detailed description of the preferred embodiment with reference to the accompanying drawings, of which:

FIG. 1 is a front view illustrating a conventional sunshade assembly;

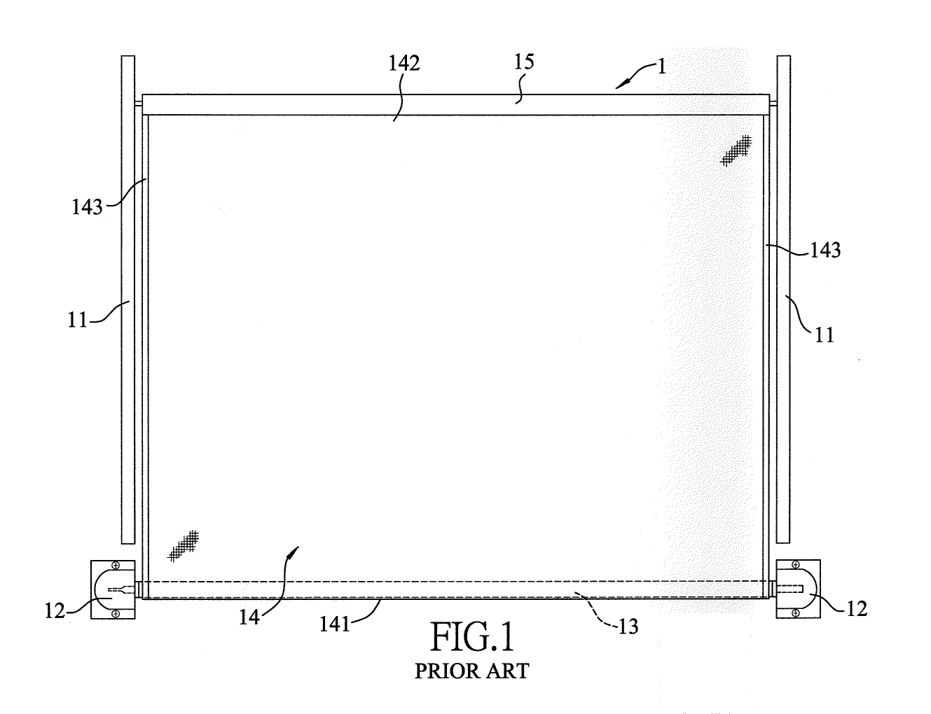

FIG. 2 is a fragmentary side sectional view of the conventional sunshade assembly;

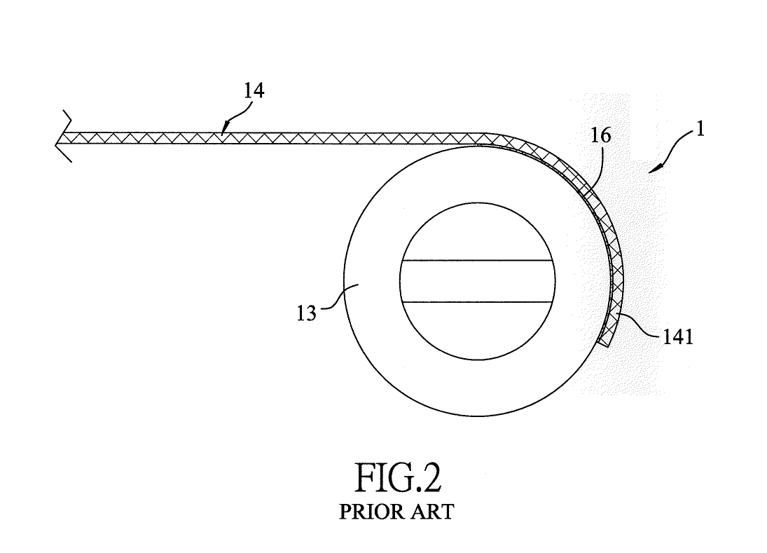

FIG. 3 is a front view illustrating the preferred embodiment of a sunshade assembly according to the present invention;

FIG. 4 is an exploded fragmentary perspective view of the preferred embodiment, illustrating arrangement of a screen, an adhesive unit and clamp rings; and

FIG. 5 is a fragmentary side sectional view of the preferred embodiment, illustrating a structure of the screen, the adhesive unit and one of the clamp rings after being connected together.

### DETAILED DESCRIPTION OF THE PREFERRED EMBODIMENT

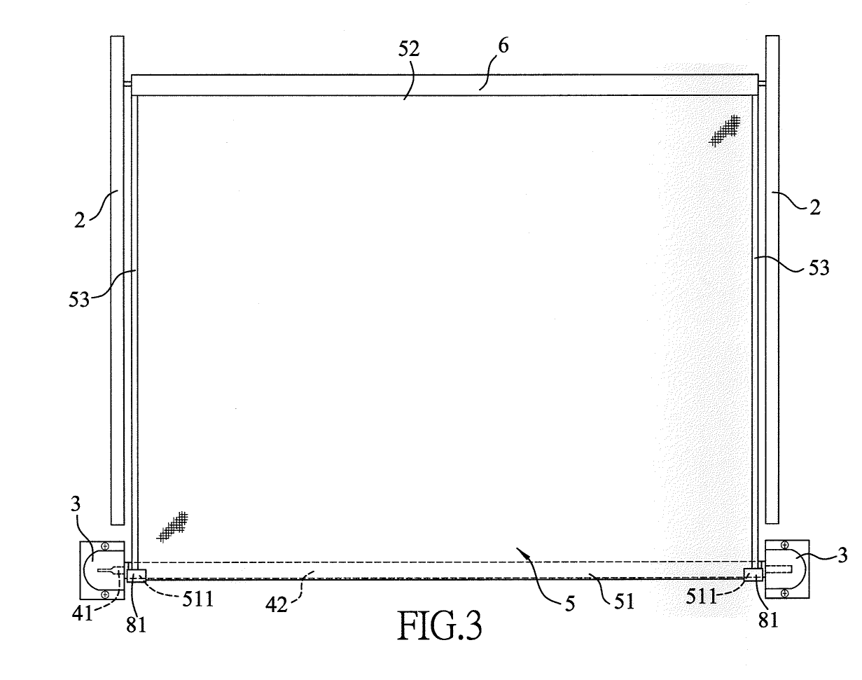

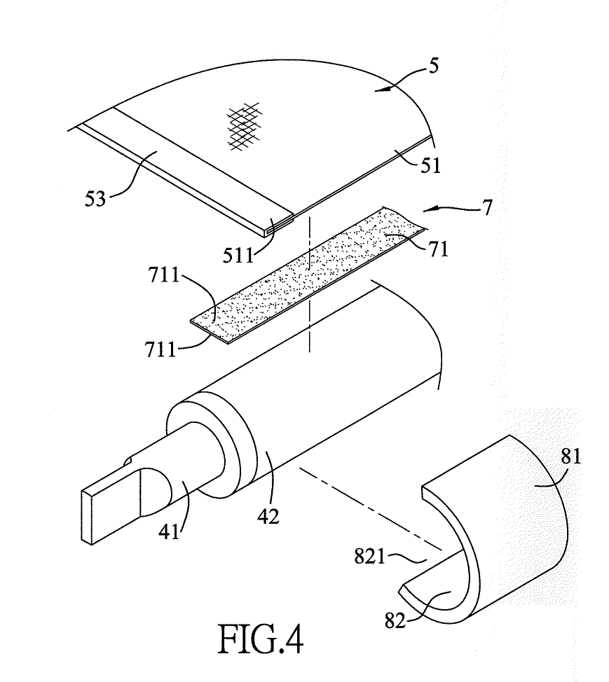

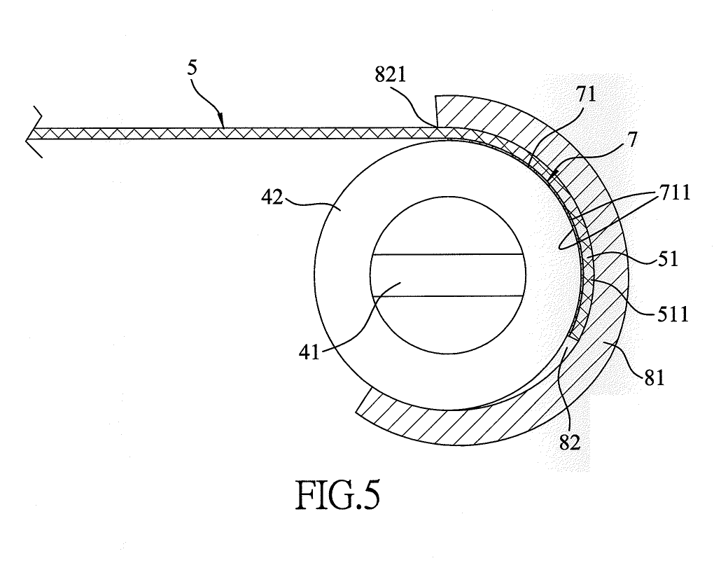

FIGS. 3 to 5 illustrate the preferred embodiment of a sunshade assembly according to the present invention. The sunshade assembly is adapted to be installed beneath a vehicle sunroof (not shown). In this preferred embodiment, the sunshade assembly includes two parallel longitudinal guide rails 2, two mounting seats 3 that are respectively disposed rearward of the guide rails 2, a winding tube 42 that has two opposite sides that are respectively connected to the mounting seats 3, a screen 5 that is extendably wound around the winding tube 42, an adhesive unit 7 that is disposed between the screen 5 and the winding tube 42, two clamp rings 81 that respectively clamp the screen 5 against the sides of the winding tube 42, and a pull rod 6 that drives the screen 5 to be extended or retracted relative to the winding tube 42. In other embodiments, the mounting seats 3 can be integrally formed in one piece. However, the present invention is not limited in this respect.

In this preferred embodiment, the sunshade assembly further includes a spindle 41. The winding tube 42 is rotatably sleeved around the spindle 41 so as to be connected to the mounting seats 3 through the spindle 41. Preferably, the sunshade assembly further includes a torsion spring (not shown) for providing a restoring force to the winding tube 42 for urging the screen 15 to be retracted. Since the feature of the present invention does not reside in the spindle 41 and the torsion spring, which may be readily appreciated by those skilled in the art, details of the same are omitted herein for the sake of brevity.

The screen 5 has a connection portion 51 that extends along a length of the winding tube 42 and that is connected to the winding tube 42, an extendable portion 52 that is opposite to the connection portion 51, and two opposite lateral sides 53 each of which interconnects the connection portion 51 and the extendable portion 52. The connection portion 51 has two opposite end sections 511 that are respectively connected to the lateral sides 53.

In this preferred embodiment, the pull rod 6 is connected to the extendable portion 52 of the screen 5. Two opposite ends of the pull rod 6 are respectively and movably engaged with the guide rails 2, such that the pull rod 6 is slidable between the guide rails 2 and along a lengthwise direction of the guide rails 2. Preferably, the pull rod 6 can be driven by hand, or by an automatic/semiautomatic driving mechanism, so as to pull and stop the screen 5 at a desired position. In other embodiments, the pull rod 6 is designed to be hooked. In such a manner, when the screen 5 is completely extended, the pull rod 6 is capable of positioning the screen 5. When there is no external force acting on the screen 5 or the pull rod 6, the screen 5 is capable of returning to its original retracted position in accordance with a structural design of the sunshade assembly.

The adhesive unit 7 is disposed between the connection portion 51 and the winding tube 42 to adhere together the connection portion 51 and the winding tube 42. Preferably, the adhesive unit 7 includes a double-sided tape 71 that is disposed between and is attached to the connection portion 51 and the winding tube 42. The double-sided tape 71 has two opposite adhesive sides 711. Before the double-sided tape 71 is applied to the sunshade assembly, there are two pieces of release, paper (not shown) respectively attached to the opposite adhesive sides 711 such that the adhesive sides 711 are protected from moisture and dust When the double-sided tape 71 is to be applied to the sunshade assembly, the pieces of release paper are respectively torn from the adhesive sides 711, and the connection portion 51 and the winding tube 42 are respectively attached to the adhesive sides 711. In this preferred embodiment, the double-sided tape 71 is provided with a size that corresponds to that of the connection portion 51. However, a number or the size of the double-sided tape 71 of the adhesive unit 7 may be varied. In other words, the adhesive unit 7 can have a plurality of smaller sized double-sided tapes 71 for attaching the connection portion 51. In addition, the double-side tape 71 can be replaced by glue as long as attachment of the connection portion 51 to the winding tube 42 is accomplished.

In this preferred embodiment, the clamp rings 81 respectively clamp the end sections 511 of the screen 5 against the winding tube 42. Preferably, each of the clamp rings 81 is a C-shaped resilient ring that is disposed around the winding tube 42 and a respective one of the end sections 511 of the screen 5, and that has an opening 821 with a width smaller than an outer diameter of the winding tube 42. In addition, each of the clamp rings 81 defines a receiving space 82 that communicates with the opening 821. The receiving space 82 of each of the clamp rings 81 receives part of the winding tube 42 and the respective one of the end sections 511 of the screen 5. As a result, the respective one of the end sections 511 of the screen 5 is sandwiched between the respective one of the sides of the winding tube 42 and a respective one of the clamp rings 81. By virtue of the clamp rings 81, the end sections 511 of the screen 5 are respectively prevented from detaching from the winding tube 42. It is noted that each of the clamp rings 81 may vary in configuration or size.

During assembly, one of the adhesive sides 711 of the double-sided tape 7 is first adhered to the connection portion 51 of the screen 5. Next, the other of the adhesive sides 711 of the double-sided tape 7 is adhered to the winding tube 42 such that the connection portion 51 is attached to the winding tube 42 via the double-sided tape 7. Then, the clamp rings 81 are respectively pushed toward the end sections 511 of the connection portion 51 of the screen 5 with respect to the sides of the winding tube 42 such that the openings 821 of the clamp rings 81 are respectively and resiliently enlarged. When the end sections 511 of the screen 5 and the corresponding parts of the winding tube 42 are respectively received in the receiving spaces 82 of the clamp rings 81, the openings 821 of the clamp rings 81 are respectively and resiliently restored, and thus, the end sections 511 of the screen 5 are sandwiched between the sides the winding tube 42 and the clamp rings

To sum up, by virtue of the clamp rings 81 respectively clamping the end sections 511 of the screen 5 against the winding tube 42, the screen 5 is effectively and firmly attached to the winding tube 42. Hence, the probability of the sunshade assembly passing the tension durability test is increased, and the production yield of the sunshade assembly can be greatly improved.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A sunshade assembly, comprising:
a winding tube;
a screen extendably wound around said winding tube, said screen having, a connection portion that extends along a length of said winding tube and that is connected to said winding tube, an extendable portion that is opposite to said connection portion, and two opposite lateral sides each of which interconnects said connection portion and said extendable portion, said connection portion having two opposite end sections that are respectively connected to said lateral sides;
an adhesive unit disposed between said connection portion and said winding tube to adhere together said connection portion and said winding tube; and
two clamp rings respectively clamping said end sections against said winding tube.

2. The sunshade assembly as claimed in claim 1, wherein each of said clamp rings is a C-shaped resilient ring that is disposed around said winding tube and a respective one of said end sections, and that has an opening with a width smaller than an outer diameter of said winding tube.

3. The sunshade assembly as claimed in claim 2, wherein said adhesive unit includes a double-sided tape that is disposed between and that is attached to said connection portion and said winding tube.
